(19) United States
(12) Patent Application Publication
(10) Pub. No.: US 2023/0262645 A1
(43) Pub. Date: Aug. 17, 2023

(54) PROCEDURE TO ASSIST NETWORK FOR TRANSMISSION TIMING CALIBRATION FOR POSITIONING ACCURACY ENHANCEMENT

(71) Applicant: MEDIATEK INC., Hsinchu City (TW)

(72) Inventors: Chiao-Yao CHUANG, Hsinchu City (TW); Nathan Edward TENNY, San Jose, CA (US); Ming-Chun CHIANG, Hsinchu City (TW)

(21) Appl. No.: 18/005,484

(22) PCT Filed: Jul. 20, 2021
(86) PCT No.: PCT/CN2021/107348

§ 371 Date: Jan. 13, 2023

Related U.S. Application Data
(60) Provisional application No. 63/131,827, filed on Dec. 30, 2020.
(60) Provisional application No. 63/053,761, filed on Jul. 20, 2020.

(51) Int. Cl. H04W 64/00

(52) U.S. Cl. CPC H04W 64/00

(57) ABSTRACT

In an aspect of the disclosure, a serving base station receives, from a UE, a measurement of a DL-RSTD with respect to a first TRP and a second TRP. The serving base station sends the DL-RSTD to a location management function, wherein the location management function further receives a first RTOA of an SRS arriving at the first TRP and a second RTOA of the SRS arriving at the second TRP. The serving base station receives, from the location management function, a relative time difference calculated based on the DL-RSTD, the first RTOA, and the second RTOA. The relative time difference indicates a synchronization error between the first TRP and the second TRP.

### CROSS-REFERENCE TO RELATED APPLICATION(S)

This application claims the benefits of U.S. Provisional Application Ser. No. 63/053,761, entitled “PROCEDURE TO ASSIST NETWORK FOR TRANSMISSION TIMING CALIBRATION FOR POSITIONING ACCURACY ENHANCEMENT” and filed on Jul. 20, 2020 and U.S. Provisional Application Ser. No. 63/131,827, entitled “PROCEDURE TO ASSIST NETWORK FOR TRANSMISSION TIMING CALIBRATION FOR POSITIONING ACCURACY ENHANCEMENT” and filed on Dec. 30, 2020, both of which are expressly incorporated by reference herein in their entirety.

### FIELD

The present disclosure relates generally to communication systems, and more particularly, to techniques of positioning a user equipment (UE).

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. In one aspect, the apparatus is a serving base station of a UE. The serving base station receives, from the UE, a measurement of a downlink reference signal time difference (DL-RSTD) with respect to a first TRP and a second TRP. The serving base station sends the DL-RSTD to a location management function, wherein the location management function further receives a first relative time of arrival (RTOA) of a sounding reference signal (SRS) arriving at the first TRP and a second RTOA of the SRS arriving at the second TRP. The serving base station receives, from the location management function, a relative time difference calculated based on the DL-RSTD, the first RTOA, and the second RTOA. The relative time difference indicates a synchronization error between the first TRP and the second TRP.

In another aspect, the apparatus is a UE. The UE measures a downlink reference signal time difference (DL-RSTD) with respect to a first TRP and a second TRP based on positioning reference signals (PRSs) received from the first TRP and the second TRP. The UE transmits a sounding reference signal (SRS). The UE receives, from a serving base station of the UE, a difference between a first relative time of arrival (RTOA) of the SRS arriving at the first TRP and a second RTOA of the SRS arriving at the second TRP. The UE calculates a relative time difference based on the DL-RSTD and the difference between the first RTOA and the second RTOA. The relative time difference indicates a synchronization error between the first TRP and the second TRP.

In yet another aspect, the apparatus is a serving base station of a UE. The serving base station receives, at the serving base station and from the UE, a measurement of a downlink reference signal time difference (DL-RSTD) with respect to a first TRP and a second TRP. The serving base station obtains a first relative time of arrival (RTOA) of a sounding reference signal (SRS) arriving at the first TRP. The serving base station obtains a second RTOA of the SRS arriving at the second TRP. The serving base station sends to the UE one of: (a) the first RTOA and the second RTOA, (b) a difference between the first RTOA and the second RTOA, and (c) a relative time difference calculated based on the DL-RSTD and the difference between the first RTOA and the second RTOA. The relative time difference indicates a synchronization error between the first TRP and the second TRP.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating communications between two TRPs and a UE 704.

FIG. 8 is a diagram illustrating timing of DL slots.

FIG. 9 is a diagram illustrating timing of UL slots.

FIG. 10 is a diagram illustrating a first positioning technique.

FIG. 11 is a diagram illustrating a second positioning technique.

FIG. 12 is a diagram illustrating a third positioning technique.

FIG. 13 is a diagram illustrating transmission between a group UEs and a group of TRPs.

FIG. 14 is a flow chart 1400 of a method (process) for determining a relative time difference.

FIG. 15 is a flow chart 1400 of another method (process) for determining a relative time difference.

FIG. 16 is a flow chart 1400 of yet another method (process) for determining a relative time difference.

FIG. 17 is a diagram illustrating an example of a hardware implementation for an apparatus employing a processing system.

FIG. 18 is a diagram illustrating another example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

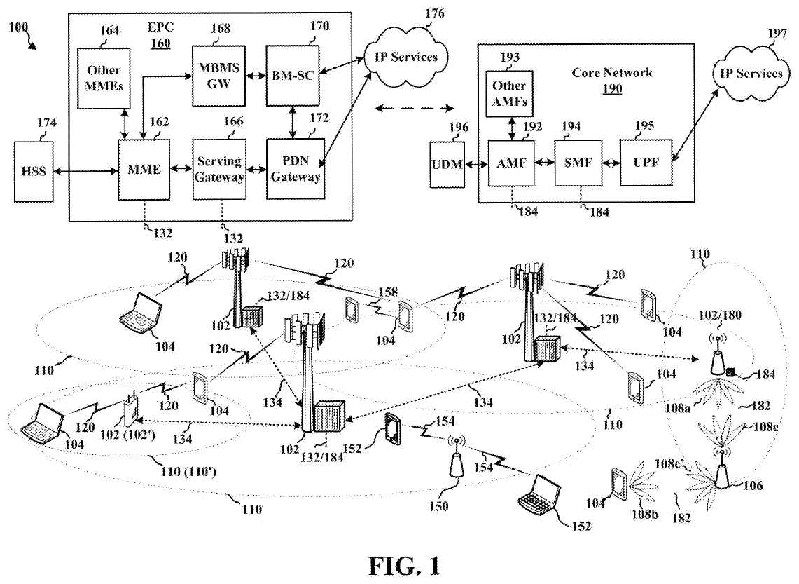

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

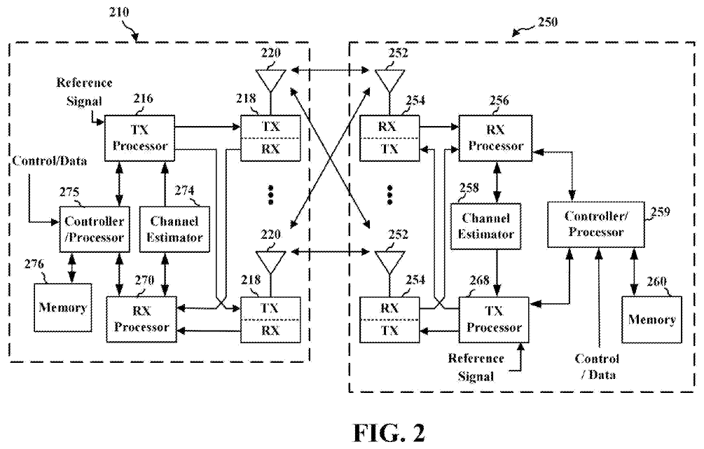

FIG. 2 is a block diagram of a base station 210 in communication with a UE 250 in an access network. In the DL, IP packets from the core network 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the core network 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the core network 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

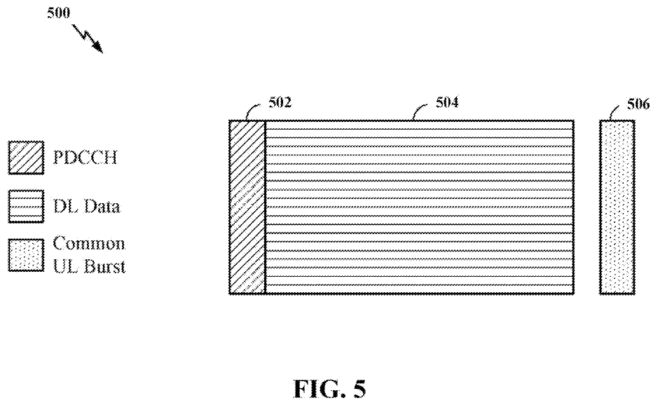

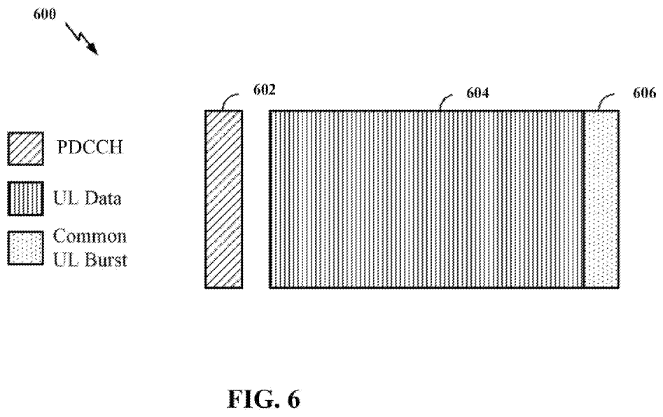

A single component carrier bandwidth of 100 MHz may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

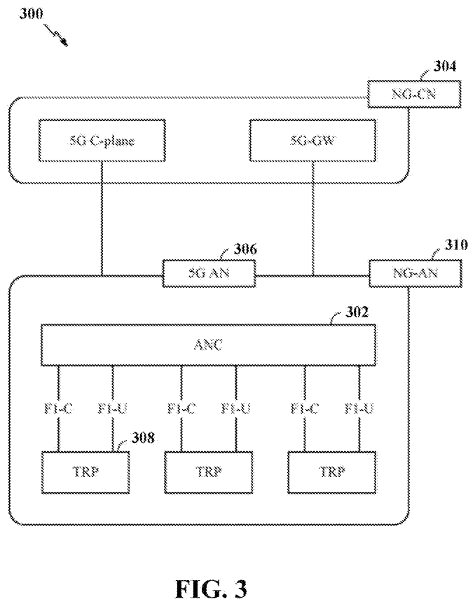

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

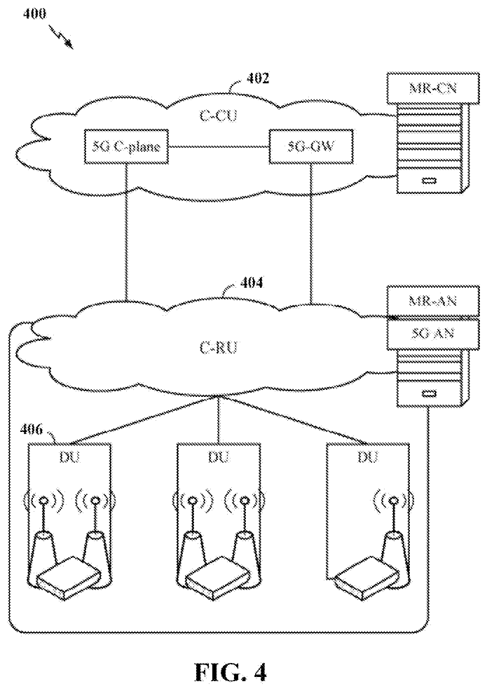

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

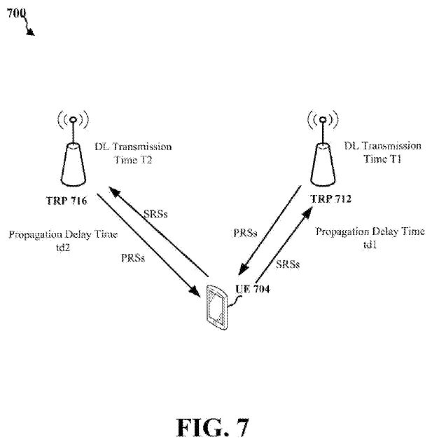

FIG. 7 is a diagram 700 illustrating communications between two TRPs (i.e., TRP 712 and TRP 716) and a UE 704. The TRP 712 and the TRP 716 may be associated with the same base station or different base stations. When employing the downlink time difference of arrival (DL-TDOA) positioning technique, the UE 704 measure several downlink reference signal time difference (DL-RSTD) values. Each DL-RSTD corresponds to the received time difference between two TRPs. For example, when the TRP 712 and the TRP 716 each transmit a set of PRSs at the same time point, the time difference between the UE 704 receives the PRSs from the TRP 712 and the TRP 716 is a DL-RSTD.

In this example, under the instruction of a base station, the TRP 712 transmits a set of PRSs at time point T1. Because of a synchronization error (relative time difference), the TRP 716 transmits a set of PRSs at time point T2, where T2=(T1+ΔT) and ΔT is the synchronization error (relative time difference).

The propagation delay time from TRP 712 to the UE 704 is td1. The propagation delay time from the TRP 716 to the UE 704 is td2. Therefore, the UE 704 receives the PRSs from the TRP 712 at time point (T1+td1) and receives the PRSs from the TRP 716 at time point (T2+td2). Accordingly, the DL-RSTD measured at the UE 704 is (T1+td1)−(T2+td2)=(td1−td2)+(T1−T2)=(td1−td2)−ΔT.

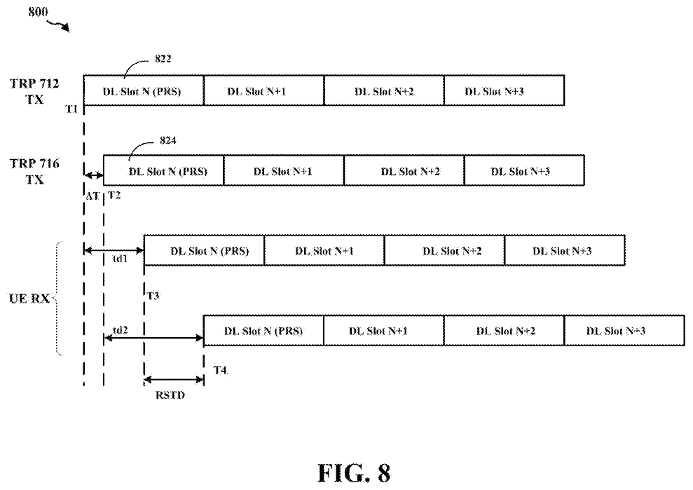

FIG. 8 is a diagram 800 illustrating timing of DL slots. In this example, the TRP 712 and the TRP 716 each transmit modulation symbols (including PRSs) in DL slot N to DL slot N+3. Because of the synchronization error (relative time difference) between the TRP 712 and the TRP 716, the starting boundary of the slot 824 (which is the DL slot N transmitted from the TRP 716) is ΔT subsequent to the starting boundary of the slot 824 (which is the DL slot N transmitted from the TRP 716).

The UE 704 detects the time of arrival of the slot 822 at time point T3 and the time of arrival of the slot 824 at time point T4. The propagation delay time from the TRP 712 to the UE 704 is td1. The propagation delay time from the TRP 716 to the UE 704 is td2.

The UE 704 measures the time difference between time point T3 and time point T4, which is the DL-RSTD. As described supra, the DL-RSTD is td1−td2−ΔT.

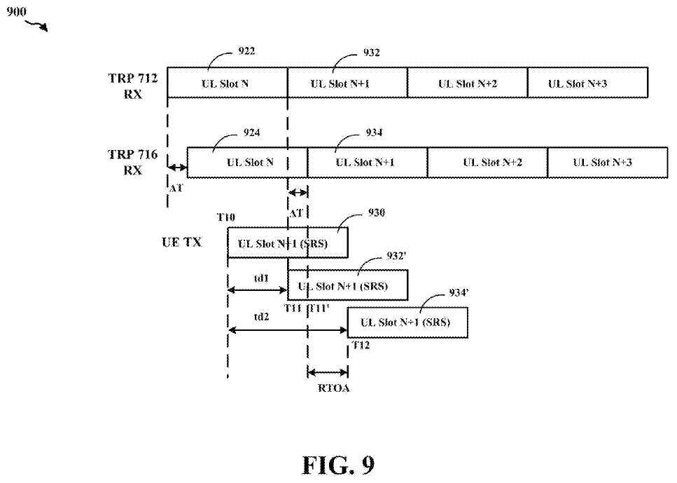

FIG. 9 is a diagram 900 illustrating timing of UL slots. The TRP 712 and the TRP 716 each are configured with an UL structure including UL slot N to UL slot N+3. Because of the synchronization error (relative time difference) as described supra, the slot 924 (which is the UL slot N configured for the TRP 716) is ΔT subsequent to the slot 922 (which is the UL slot N configured for the TRP 712).

The UE 704 transmits SRSs in a slot 930 that corresponds to the UL slot N+1. The UE 704 starts transmitting slot 930 at T10, which is configured in accordance with the timing advance related to the serving TRP of the UE 704. The TRP 712 receives, in a slot 932′, the transmission occurred in the slot 930. In one particular example, the TRP 712 is the serving TRP of the UE 704. Accordingly, the slot 932′ is aligned with a slot 932, which is the UL slot N+1 configured at the TRP 712. That is, the starting boundaries of the slot 932 and the time of arrival of the slot 932′ are at T11. The time difference between time point T10 and time point T11 is the propagation delay time td1.

The TRP 716 receives, in a slot 934′, the transmission occurred in the slot 930. The time of arrival of the slot 934′ is at T12. The starting boundary of a slot 934, which is the UL slot N+1 configured at the TRP 716, is at T11′, which is prior to T12. The time difference between time point T10 and time point T12 is the propagation delay time td2.

As such, the relative time of arrival (RTOA) can be determined. RTOA #1 at TRP 712 with reference to the starting boundary of the UL slot N+1 is the time difference between the starting boundaries of the slot 932 and the slot 932′, and is 0. RTOA #2 at TRP 716 with reference to the starting boundary of the UL slot N+1 is the time difference between the starting boundaries of the slot 934 and the slot 934′, and is (td2−td1−ΔT).

Further, UL-RSTD is define as (RTOA #1-RTOA #2), which is 0−(td2−td1−ΔT)=td1−td2+ΔT. Further, as described supra, DL-RSTD=td1−td2−ΔT. Therefore: UL-RSTD+DL-RSTD=2*(td1−td2); UL-RSTD—DL-RSTD=2*ΔT. As such, both (td1−td2) and ΔT can be estimated.

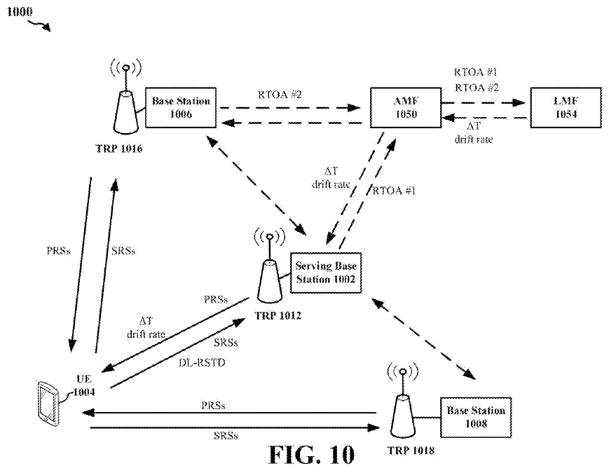

FIG. 10 is a diagram 700 illustrating a first positioning technique. A base station 1002, and its neighboring base station 1006 and base station 1008, are in communication with each other, and are also in communication with an AMF 1050. The AMF 1050 is in communication with an LMF 1054. The communications may utilize NAS messages. Further, the base station 1002 operates a TRP 1012. The base station 1006 operates a TRP 1016. The base station 1008 operates a TRP 1018.

In this first positioning technique, for example, the base station 1002 configures (e.g., through RRC messages) the UE 1004 to transmits SRSs directed to the TRP 1012 as well as TRPs of the neighboring base stations. Further, the TRP 1012 and the TRPs of the neighboring base stations transmit PRSs to the UE 1004.

Similar to what was described supra referring FIG. 7, the UE 1004 detects PRSs transmitted from the TRP 1012 and PRSs transmitted from the TRP 1016. Accordingly, the UE 1004 can measure the DL-RSTD corresponding to the TRP 1012 and the TRP 1016. In particular, the DL-RSTD can be represented as td1−td2−ΔT as described supra, where td1 is the propagation delay time between the TRP 1012 and the UE 1004, td2 is the propagation delay time between the TRP 1016 and the UE 1004, ΔT is the synchronization error (relative time difference) between the TRP 1012 and the TRP 1016. The UE 1004 transmits the measured DL-RSTD to its serving base station, i.e., the base station 1002, which then sends the DL-RSTD to the LMF 1054 through the AMF 1050. The DL-RSTD measurement is tagged with a time stamp.

Further, as described supra, the UE 1004 was configured to transmit SRSs or other uplink reference signals to TRPs surrounding the UE 1004. Accordingly, the TRP 1012 receives the SRSs from the UE 1004, and performs, similarly to was described supra referring to FIG. 9, RTOA measurement of the SRSs based on the reference time configured through NR Positioning Protocol A (NRPPa) or other suitable protocols. The TRP 1012 sends an RTOA #1 it measured to the base station 1002, which forwards the RTOA #1 with a corresponding timestamp to the LMF 1054 through the AMF 1050.

Similarly, the TRP 1016 detects SRSs transmitted from the UE 1004 and measures an RTOA #2, and sends the RTOA #2 to the base station 1006. The base station 1006 forwards the RTOA #2 with a corresponding timestamp to the LMF 1054 through the AMF 1050.

As such, the LMF 1054 has received a DL-RSTD with respect to the TRP 1012 and the TRP 1016. The LMF 1054 has also received the RTOA #1 measured at the TRP 1012 and the RTOA #2 measured at the TRP 1016.

Accordingly, the LMF 1054 can use the techniques of manipulating DL-RSTD and UL-RSTD described supra with respect to FIG. 9 to estimate the synchronization error (relative time difference) ΔT between the TRP 1012 and the TRP 1016. Further, the drift rate of ΔT can also be tracked.

The LMF 1054 sends the estimated ΔT and the corresponding drift rate to the base station 1002 via the AMF 1050. The base station 1002 can send the ΔT and the drift rate with corresponding time stamp to the UE 1004 as the close loop mechanism for network synchronization error mitigation. The LMF 1054 can send the synchronization error (relative time difference) between the TRP 1012 and the TRP 1016 to other UEs managed by the AMF 1050.

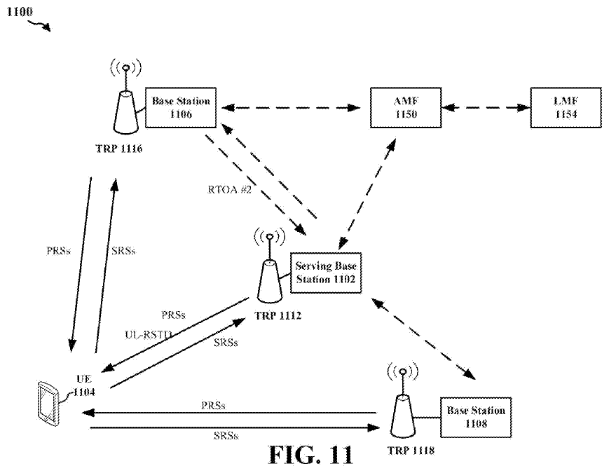

FIG. 11 is a diagram 1100 illustrating a second positioning technique. A base station 1102, and its neighboring base station 1106 and base station 1108, are in communication with each other, and are also in communication with a AMF 1150. The AMF 1150 is in communication with an LMF 1154. The communications may utilize NAS messages. Further, the base station 1102 operates a TRP 1112. The base station 1106 operates a TRP 1116. The base station 1188 operates a TRP 1118.

In this second positioning technique, for example, the base station 1102 configures (e.g., through RRC messages) the UE 1104 to transmits SRSs directed to the TRP 1112 as well as TRPs of the neighboring base stations. Further, the TRP 1112 and the TRPs of the neighboring base stations transmit PRSs to the UE 1104.

Similar to what was described supra referring FIG. 7, in one example, the UE 1104 detects PRSs transmitted from the TRP 1112 and PRSs transmitted from the TRP 1116. Accordingly, the UE 1104 can measure the DL-RSTD corresponding to the TRP 1112 and the TRP 1116. In particular, the DL-RSTD can be represented as td1−td2−ΔT as described supra, where td1 is the propagation delay time between the TRP 1112 and the UE 1104, td2 is the propagation delay time between the TRP 1116 and the UE 1104, ΔT is the synchronization error (relative time difference) between the TRP 1112 and the TRP 1116.

Further, as described supra, the UE 1104 was configured to transmit SRSs or other uplink reference signals to TRPs surrounding the UE 1104. Accordingly, the TRP 1112 receives the SRSs from the UE 1104, and performs, similarly to was described supra referring to FIG. 9, RTOA measurement of the SRSs based on the reference time configured through NR Positioning Protocol A (NRPPa) or other suitable protocols. The TRP 1112 sends an RTOA #1 it measured to the base station 1102.

Similarly, the TRP 1116 detects SRSs transmitted from the UE 1104 and measures an RTOA #2, and sends the RTOA #2 to the base station 1106. The base station 1106 determines that the serving base station of the UE 1104 is the base station 1102, and accordingly forwards the RTOA #2 with a corresponding timestamp to the base station 1102 through, e.g., the Xn interface.

As such, the base station 1102 has received the RTOA #1 measured at the TRP 1112 and the RTOA #2 measured at the TRP 1116. Accordingly, the base station 1102 can determine a UL-RSTD (i.e., td1−td2+ΔT) described supra with respect to FIG. 9. The base station 1102 further sends the UL-RSTD to the UE 1104 through the TRP 1112.

The UE 1104 obtained the DL-RSTD and the UL-RSTD. Accordingly, the UE 1104 can use the techniques of manipulating DL-RSTD and UL-RSTD described supra with respect to FIG. 9 to estimate the synchronization error (relative time difference) ΔT between the TRP 1112 and the TRP 1116. Further, the drift rate of ΔT between two the TRP 1112 and the TRP 1116 can be derived through a period of observation.

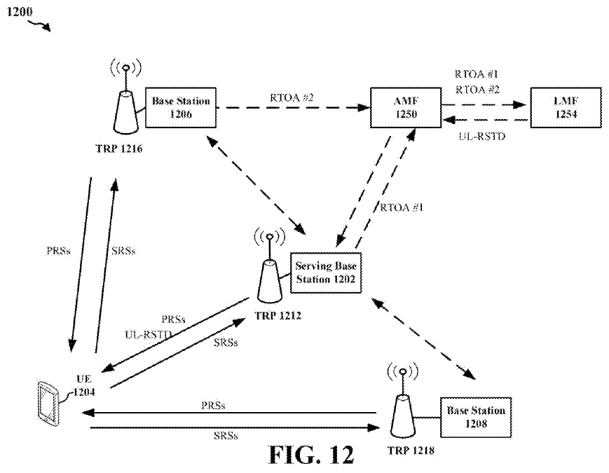

FIG. 12 is a diagram 1200 illustrating a third positioning technique. A base station 1202, and its neighboring base station 1206 and base station 1208, are in communication with each other, and are also in communication with an AMF 1250. The AMF 1250 is in communication with an LMF 1254. The communications may utilize NAS messages. Further, the base station 1202 operates a TRP 1212. The base station 1206 operates a TRP 1216. The base station 1288 operates a TRP 1218.

In this third positioning technique, for example, the base station 1202 configures (e.g., through RRC messages) the UE 1204 to transmits SRSs directed to the TRP 1212 as well as TRPs of the neighboring base stations. Further, the TRP 1212 and the TRPs of the neighboring base stations transmit PRSs to the UE 1204.

Similar to what was described supra referring FIG. 7, in one example, the UE 1204 detects PRSs transmitted from the TRP 1212 and PRSs transmitted from the TRP 1216.

Accordingly, the UE 1204 can measure the DL-RSTD corresponding to the TRP 1212 and the TRP 1216. In particular, the DL-RSTD can be represented as td1−td2−ΔT as described supra, where td1 is the propagation delay time between the TRP 1212 and the UE 1204, td2 is the propagation delay time between the TRP 1216 and the UE 1204, ΔT is the synchronization error (relative time difference) between the TRP 1212 and the TRP 1216.

Further, as described supra, the UE 1204 was configured to transmit SRSs or other uplink reference signals to TRPs surrounding the UE 1204. Accordingly, the TRP 1212 receives the SRSs from the UE 1204, and performs, similarly to was described supra referring to FIG. 9, RTOA measurement of the SRSs based on the reference time configured through NR Positioning Protocol A (NRPPa) or other suitable protocols. The TRP 1212 sends an RTOA #1 it measured to the base station 1202, which forwards the RTOA #1 with a corresponding timestamp to the LMF 1254 through the AMF 1250.

Similarly, the TRP 1216 detects SRSs transmitted from the UE 1204 and measures an RTOA #2, and sends the RTOA #2 to the base station 1206. The base station 1206 forwards the RTOA #2 with a corresponding timestamp to the LMF 1254 through the AMF 1250.

As such, the LMF 1254 has received the RTOA #1 measured at the TRP 1212 and the RTOA #2 measured at the TRP 1216. Accordingly, the LMF 1254 can determine a UL-RSTD (i.e., td1−td2+ΔT) described supra with respect to FIG. 9. The LMF 1254 can send, via the AMF 1250, the UL-RSTD to the base station 1202, which further sends the UL-RSTD to the UE 1204 through the TRP 1212.

The UE 1204 obtained the DL-RSTD and the UL-RSTD. Accordingly, the UE 1204 can use the techniques of manipulating DL-RSTD and UL-RSTD described supra with respect to FIG. 9 to estimate the synchronization error (relative time difference) ΔT between the TRP 1212 and the TRP 1216. Further, the drift rate of ΔT between two the TRP 1212 and the TRP 1216 can be derived through a period of observation.

In certain configurations, the UE 1204 can send the estimated synchronization error (relative time difference) to the base station 1202, which forwards the synchronization error (relative time difference) to the LMF 1254 via the AMF 1250. The LMF 1254 can send the synchronization error (relative time difference) between the TRP 1212 and the TRP 1216 to other UEs managed by the AMF 1250.

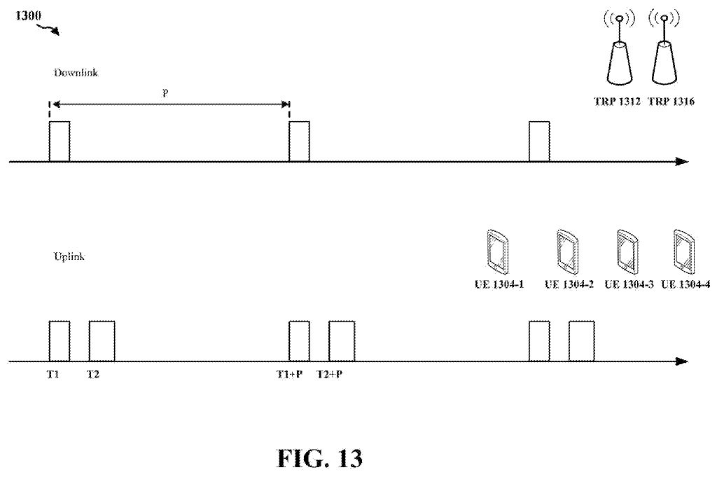

FIG. 13 is a diagram 1300 illustrating transmission between a group UEs including UEs 1304-1 . . . 1304-4 and a group of TRPs including a TRP 1312 and a TRP 1316. In the downlink transmission, the TRP 1312 and the TRP 1316 periodically transmit PRSs e.g., a period P (e.g., 160 ms). As the synchronization error (relative time difference) between the TRP 1312 and the TRP 1316 is common to all the UEs 1304-1 . . . 1304-4. The UEs 1304-1 . . . 1304-4 may take turns to transmit SRSs on the uplink in order to combine downlink measurements for synchronization error estimation at the location server (LMF). Therefore the uplink SRS overhead may be reduced. The estimated synchronization error (relative time difference) can be applied to correct the DL-RSTD measurements reported by each of the UEs 1304-1 . . . 1304-4.

In this example, at T1, only the UE 1304-1 (not the other UEs) transmits SRS. At T2, each of the UEs 1304-1 . . . 1304-4 reports their respective DL-RSTD reports to their respective serving base stations. At T1+P, only the UE 1304-2 (not the other UEs) transmits SRS. At T2+P, each of the UEs 1304-1 . . . 1304-4 reports their respective DL-RSTD reports to their respective serving base stations.

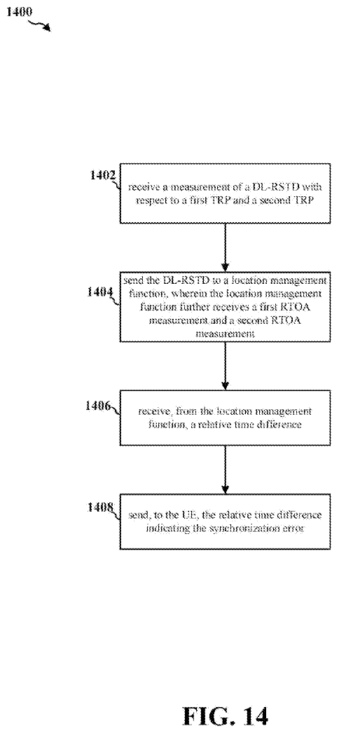

FIG. 14 is a flow chart 1400 of a method (process) for determining a relative time difference. The method may be performed by a serving base station (e.g., the base station 1002) of a UE. At operation 1402, the serving base station receives, from the UE, a measurement of a downlink reference signal time difference (DL-RSTD) with respect to a first TRP and a second TRP. At operation 1404, the serving base station sends the DL-RSTD to a location management function. The location management function further receives a first relative time of arrival (RTOA) measurement of a sounding reference signal (SRS) arriving at the first TRP and a second RTOA measurement of the SRS arriving at the second TRP. At operation 1406, the serving base station receives, from the location management function, a relative time difference calculated based on the DL-RSTD, the first RTOA, the second RTOA. The relative time difference indicates a synchronization error between the first TRP and the second TRP. In certain configurations, the location management function sends the relative time difference to one or more base stations neighboring the serving base station. Further, those neighboring base stations may send the relative time difference to UEs served by those neighboring base stations. At operation 1408, the serving base station sends, to the UE, the relative time difference indicating the synchronization error.

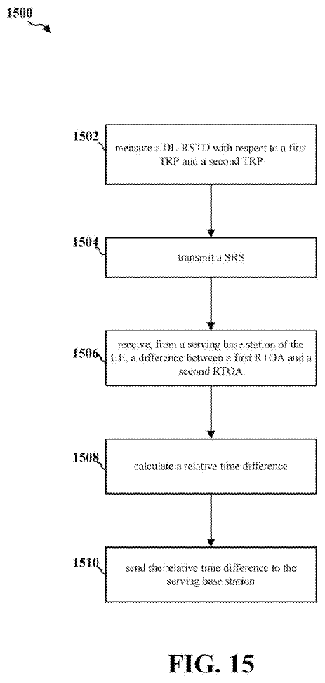

FIG. 15 is a flow chart 1500 of a method (process) for determining a relative time difference. The method may be performed by a UE (e.g., the UE 704, the UE 1004, the UE 1104, the UE 1204, and the UEs 1304-1 . . . 1304-4). At operation 1502, the UE measures a downlink reference signal time difference (DL-RSTD) with respect to a first TRP and a second TRP based on positioning reference signals (PRSs) received from the first TRP and the second TRP. At operation 1504, the UE transmits a sounding reference signal (SRS). At operation 1506, the UE receives, from a serving base station of the UE, a difference between a first relative time of arrival (RTOA) of the SRS arriving at the first TRP and a second RTOA of the SRS arriving at the second TRP. At operation 1508, the UE calculates a relative time difference based on the DL-RSTD and the difference between the first RTOA and the second RTOA, the relative time difference indicating a synchronization error between the first TRP and the second TRP. In certain configurations, the difference between the first RTOA and the second RTOA is calculated at the serving base station. In certain configurations, the difference between the first RTOA and the second RTOA is calculated at the location management function. At operation 1510, the UE sends the relative time difference to the serving base station.

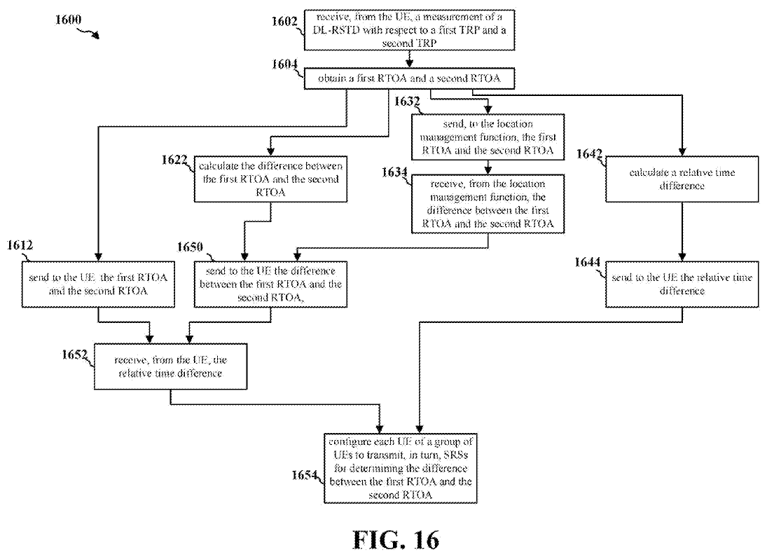

FIG. 16 is a flow chart 1600 of a method (process) for determining a relative time difference. The method may be performed by a serving base station (e.g., the base station 1102 and the base station 1202) of a UE. At operation 1602, the serving base station receives, from the UE, a measurement of a downlink reference signal time difference (DL-RSTD) with respect to a first TRP and a second TRP. At operation 1604, the serving base station obtains a first RTOA of an SRS arriving at the first TRP and a second RTOA of the SRS arriving at the second TRP. In certain configurations, at least one the first RTOA and the second RTOA is obtained by the serving base station from a base station, of the first TRP or the second TRP, that is neighboring the serving base station.

Subsequent to operation 1604, in a first configuration, at operation 1612, the serving base station sends to the UE the first RTOA and the second RTOA. Then, the serving base station enters into operation 1652.

Subsequent to operation 1604, in a second configuration, at operation 1622, the serving base station calculates the difference between the first RTOA and the second RTOA. Then, the serving base station enters into operation 1650.

Subsequent to operation 1604, in a third configuration, at operation 1632, the serving base station sends to a location management function the first RTOA and the second RTOA. Accordingly, the location management function calculates the difference between the first RTOA and the second RTOA. At operation 1634, the serving base station receives, from the location management function, the difference between the first RTOA and the second RTOA. Then, the serving base station enters into operation 1650.

At operation 1650, the serving base station sends to the UE the difference between the first RTOA and the second RTOA. Then, the serving base station enters into operation 1654.

In the first, second, and third configurations, the UE receives from the serving base station the first and second RTOAs or the difference between the first RTOA and the second RTOA. The UE accordingly calculates the relative time difference based on the DL-RSTD and the difference between the first RTOA and the second RTOA as described supra. The relative time difference indicates a synchronization error between the first TRP and the second TRP. The UE then may send the relative time difference to the serving base station. At operation 1652, the serving base station receives from the UE the relative time difference. Then, the serving base station enters into operation 1652.

Subsequent to operation 1604, in a fourth configuration, at operation 1642, the serving base station calculates the relative time difference based on the DL-RSTD and the difference between the first RTOA and the second RTOA as described supra. The relative time difference indicates a synchronization error between the first TRP and the second TRP. At operation 1644, the serving base station sends the relative time difference to the UE. Then, the serving base station enters into operation 1654.

In certain configurations, at operation 1654, the serving base station configures each UE of a group of UEs to transmit, in turn, SRSs for determining the difference between the first RTOA and the second RTOA.

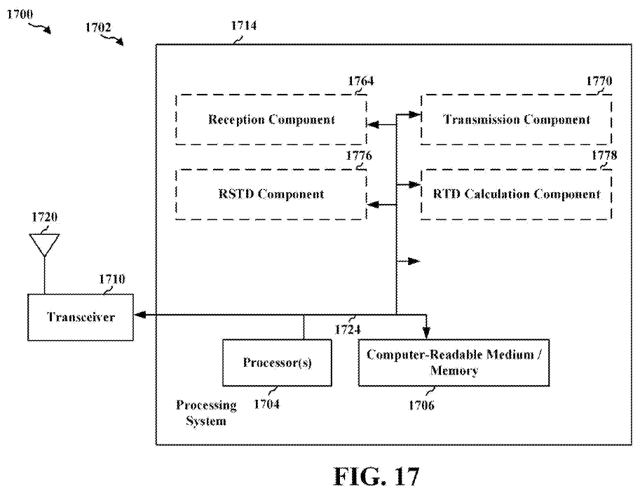

FIG. 17 is a diagram 1700 illustrating an example of a hardware implementation for an apparatus 1702 employing a processing system 1714. The apparatus 1702 may be a base station. The processing system 1714 may be implemented with a bus architecture, represented generally by a bus 1724. The bus 1724 may include any number of interconnecting buses and bridges depending on the specific application of the processing system 1714 and the overall design constraints. The bus 1724 links together various circuits including one or more processors and/or hardware components, represented by one or more processors 1704, the reception component 1764, the RSTD component 1776, the RTD calculation component 1778, the transmission component 1770, and a computer-readable medium/memory 1706. The bus 1724 may also link various other circuits such as timing sources, peripherals, voltage regulators, and power management circuits, etc.

The processing system 1714 may be coupled to a transceiver 1710, which may be one or more of the transceivers 354. The transceiver 1710 is coupled to one or more antennas 1720, which may be the communication antennas 320.

The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception component 1764. In addition, the transceiver 1710 receives information from the processing system 1714, specifically the transmission component 1770, and based on the received information, generates a signal to be applied to the one or more antennas 1720.

The processing system 1714 includes one or more processors 1704 coupled to a computer-readable medium/memory 1706. The one or more processors 1704 are responsible for general processing, including the execution of software stored on the computer-readable medium/memory 1706. The software, when executed by the one or more processors 1704, causes the processing system 1714 to perform the various functions described supra for any particular apparatus. The computer-readable medium/memory 1706 may also be used for storing data that is manipulated by the one or more processors 1704 when executing software. The processing system 1714 further includes at least one of the reception component 1764, the RSTD component 1776, the RTD calculation component 1778, and the transmission component 1770. The components may be software components running in the one or more processors 1704, resident/stored in the computer readable medium/memory 1706, one or more hardware components coupled to the one or more processors 1704, or some combination thereof. The processing system 1714 may be a component of the base station 310 and may include the memory 376 and/or at least one of the TX processor 316, the RX processor 370, and the controller/processor 375.

In one configuration, the apparatus 1702 for wireless communication includes means for performing each of the operations of FIGS. 14 and 16. The aforementioned means may be one or more of the aforementioned components of the apparatus 1702 and/or the processing system 1714 of the apparatus 1702 configured to perform the functions recited by the aforementioned means.

As described supra, the processing system 1714 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

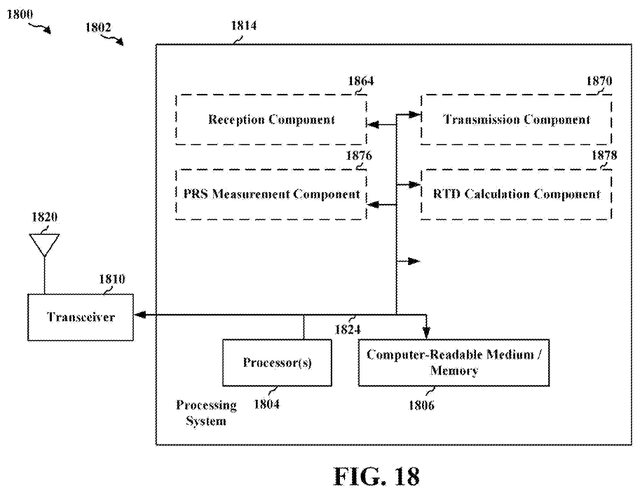

FIG. 18 is a diagram 1800 illustrating an example of a hardware implementation for an apparatus 1802 employing a processing system 1814. The apparatus 1802 may be a UE. The processing system 1814 may be implemented with a bus architecture, represented generally by a bus 1824. The bus 1824 may include any number of interconnecting buses and bridges depending on the specific application of the processing system 1814 and the overall design constraints. The bus 1824 links together various circuits including one or more processors and/or hardware components, represented by one or more processors 1804, the reception component 1864, the measurement component 1876, the RTD calculation component 1878, the transmission component 1870, and a computer-readable medium/memory 1806. The bus 1824 may also link various other circuits such as timing sources, peripherals, voltage regulators, and power management circuits, etc.

The processing system 1814 may be coupled to a transceiver 1810, which may be one or more of the transceivers 354. The transceiver 1810 is coupled to one or more antennas 1820, which may be the communication antennas 352.

The transceiver 1810 provides a means for communicating with various other apparatus over a transmission medium. The transceiver 1810 receives a signal from the one or more antennas 1820, extracts information from the received signal, and provides the extracted information to the processing system 1814, specifically the reception component 1864. In addition, the transceiver 1810 receives information from the processing system 1814, specifically the transmission component 1870, and based on the received information, generates a signal to be applied to the one or more antennas 1820.

The processing system 1814 includes one or more processors 1804 coupled to a computer-readable medium/memory 1806. The one or more processors 1804 are responsible for general processing, including the execution of software stored on the computer-readable medium/memory 1806. The software, when executed by the one or more processors 1804, causes the processing system 1814 to perform the various functions described supra for any particular apparatus. The computer-readable medium/memory 1806 may also be used for storing data that is manipulated by the one or more processors 1804 when executing software. The processing system 1814 further includes at least one of the reception component 1864, the measurement component 1876, the RTD calculation component 1878, and the transmission component 1870. The components may be software components running in the one or more processors 1804, resident/stored in the computer readable medium/memory 1806, one or more hardware components coupled to the one or more processors 1804, or some combination thereof. The processing system 1814 may be a component of the UE 350 and may include the memory 360 and/or at least one of the TX processor 368, the RX processor 356, and the communication processor 359.

In one configuration, the apparatus 1802 for wireless communication includes means for performing each of the operations of FIG. 15. The aforementioned means may be one or more of the aforementioned components of the apparatus 1802 and/or the processing system 1814 of the apparatus 1802 configured to perform the functions recited by the aforementioned means.

As described supra, the processing system 1814 may include the TX Processor 368, the RX Processor 356, and the communication processor 359. As such, in one configuration, the aforementioned means may be the TX Processor 368, the RX Processor 356, and the communication processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of operating a location management function, comprising:
receiving, at the location management function and from at least one of base station, a measurement of a downlink reference signal time difference (DL-RSTD) with respect to a first transmit reception point (TRP) and a second TRP, a first relative time of arrival (RTOA) of a sounding reference signal (SRS) arriving at the first TRP and a second RTOA of the SRS arriving at the second TRP; and
sending, to the at least one base station, a relative time difference calculated based on the DL-RSTD, the first RTOA, and the second RTOA, the relative time difference indicating a synchronization error between the first TRP and the second TRP.

2. The method of claim 1, wherein the at least one base station comprises a serving base station of a UE and one or more base stations neighboring the serving base station.

3. The method of claim 1, wherein the location management function is a location server that positions a target device using position-related measurements obtained by one or more reference sources, the method further comprising:
sending, to the UE, the relative time difference indicating the synchronization error.

4. The method of claim 1, wherein a calculation to determine the relative time difference includes:
determining an RTOA difference between the first RTOA and the second RTOA; and
determining a difference between the RTOA difference and the DL-RSTD.

5. A method of wireless communication of a user equipment (UE), comprising:
measuring a downlink reference signal time difference (DL-RSTD) with respect to a first transmit reception point (TRP) and a second TRP based on positioning reference signals (PRSs) received from the first TRP and the second TRP;
transmitting a sounding reference signal (SRS);
receiving, from a serving base station of the UE, a relative time of arrival (RTOA) difference between a first (RTOA) of the SRS arriving at the first TRP and a second RTOA of the SRS arriving at the second TRP; and
calculating, at the UE, a relative time difference based on the DL-RSTD and the RTOA difference, the relative time difference indicating a synchronization error between the first TRP and the second TRP.

6. The method of claim 5, where the RTOA difference between the first RTOA and the second RTOA is calculated at the serving base station.

7. The method of claim 5, where the RTOA difference between the first RTOA and the second RTOA is calculated at the location management function.

8. The method of claim 5, further comprising:
sending the relative time difference to the serving base station.

9. The method of claim 5, wherein the calculation to determine the relative time difference includes:
determining a difference between the RTOA difference and the DL-RSTD.

10. A method of wireless communication of a serving base station of a user equipment (UE), comprising:
receiving, at the serving base station and from the UE, a measurement of a downlink reference signal time difference (DL-RSTD) with respect to a first transmit reception point (TRP) and a second TRP;
obtaining, at the serving base station, a first relative time of arrival (RTOA) of a sounding reference signal (SRS) when received at the first TRP;
obtaining, at the serving base station, a second RTOA of the SRS when received at the second TRP; and
sending, from the serving base station to the UE, one of:
(a) the first RTOA and the second RTOA,
(b) an RTOA difference between the first RTOA and the second RTOA, and
(c) a relative time difference calculated based on the DL-RSTD and the RTOA difference, the relative time difference indicating a synchronization error between the first TRP and the second TRP.

11. The method of claim 10, wherein the calculation to determine the relative time difference includes:
determining a difference between the RTOA difference and the DL-RSTD.

12. The method of claim 10, further comprising:
receiving, from the UE, a relative time difference calculated based on the DL-RSTD and the RTOA difference, the relative time difference indicating a synchronization error between the first TRP and the second TRP, when (a) the first RTOA and the second RTOA or (b) the difference between the first RTOA and the second RTOA is sent to the UE.

13. The method of claim 10, wherein at least one the first RTOA and the second RTOA is obtained by the serving base station from a base station, of the first TRP or the second TRP, that is neighboring the serving base station.

14. The method of claim 10, further comprising:
calculating, at the serving base station, the RTOA difference between the first RTOA and the second RTOA.

15. The method of claim 10, wherein the location management function receives the first RTOA and the second RTOA, the method further comprising:
receiving, at the serving base station and from the location management function, the RTOA difference between the first RTOA and the second RTOA prior to the sending the RTOA difference to the UE.

16. The method of claim 10, further comprising:
configuring at least one UE of a group of UEs to transmit, in turn, SRSs for determining the difference between the first RTOA and the second RTOA.

17. A method of wireless communication of a use equipment (UE), comprising:
measuring a downlink reference signal time difference (DL-RSTD) with respect to a first transmit reception point (TRP) and a second TRP based on positioning reference signals (PRSs) received from the first TRP and the second TRP;
transmitting the DL-RSTD and a sounding reference signal (SRS); and
receiving a relative time difference indicating a transmission timing difference between the first TRP and the second TRP responsive to the transmitting.

18. The method of claim 17, further comprising:
Sending the relative time difference to a serving base station.
